(19) United States
(12) Patent Application Publication
(10) Pub. No.: US 2024/0310193 A1
(43) Pub. Date: Sep. 19, 2024

(54) OFF-AXIS FIBER OPTIC SENSOR

(71) Applicant: Photon Control, Inc., Richmond (CA)

(72) Inventors: Yuriy SYVENKYY, Richmond (CA); Bram SADLIK, Richmond (CA); Arjun AGRAWAL, Richmond (CA); Michael FEAVER, Richmond (CA); Yoshua ICHIHASHI, Richmond (CA); Michael TISCHLER, Richmond (CA)

(73) Assignee: Photon Control Inc., Richmond (CA)

(21) Appl. No.: 18/606,120

(22) Filed: Mar. 15, 2024

Related U.S. Application Data
(60) Provisional application No. 63/452,184, filed on Mar. 15, 2023.

(51) Int. Cl. G01D 5/353

(52) U.S. Cl. CPC G01D 5/3537

(57) ABSTRACT

The present application discloses embodiments of optical assemblies used in optical sensor systems where access to the equipment components or areas to be sensed is difficult. In one embodiment, an optical assembly may include a housing having an optical waveguide operative to guide an optical signal to an optical element configured to change the direction of propagation of the optical signal orthogonal to the original direction of propagation. The optical element may have a refractive surface and a reflective surface. Use of two such optical assemblies arranged optically in series enables the user to route an optical signal to propagate along an optical axis parallel to but laterally offset from the original axis of propagation. Such optical assemblies may allow optical access to regions of semiconductor manufacturing equipment such as process chambers, wafer supports, electrostatic chucks, showerheads, edge rings, or end effectors of wafer handling robots.

### CROSS-REFERENCE TO RELATED APPLICATIONS

The present application claims priority to U.S. Provisional Patent Application Ser. No. 63/452,184-entitled “Off-Axis Fiber Optic Sensor” filed on Mar. 15, 2023, the contents of which are incorporated by reference herein.

### BACKGROUND

Optical sensors, specifically fiber optic sensors, are used for a variety of applications in semiconductor manufacturing, including the measurement of temperature, strain, and position of wafers, electrostatic chucks, showerheads, and other components in the harsh chemical and radio-frequency environment inside wafer processing chambers. Such sensors must have small form factors to access hard-to-reach regions of the chambers and their components. While prior art fiber optic sensors have proven useful in the past, a number of shortcomings have been identified. For example, when the sensing element is offset from the optical fiber that provides the light used to interact with the sensing element on the object being measured, the fiber must be bent at sharp angles. This often requires placing the fiber in a metal capillary tube to prevent bending stress from damaging the fiber. In light of the foregoing, there is an ongoing need for a fiber optic sensor capable of accessing tight spaces without risk of damaging the fiber.

### SUMMARY

The Detailed Description below relates to various embodiments of compact optical assemblies configured to change the direction of propagation of radiation in such optical sensors.

In one embodiment, the optical assembly comprises a housing, an optical element disposed at least partially within the housing and having a curved surface and a reflective surface, wherein the optical element is configured to direct a first optical radiation incident on a first portion of the curved surface to exit a second portion of the curved surface after at least partially reflecting from at least a portion of the reflective surface. The optical radiation incident on the first portion of the curved surface has a first direction of propagation along a first optical axis and the optical radiation exiting the second portion of the curved surface has a second direction of propagation along a second optical axis, wherein the second direction of propagation is different from the first direction of propagation. The optical element may be provided as a single optical element or multiple optical elements. The optical element may be provided as a half ball lens, a hyper-hemispherical lens, a hypo-hemispherical lens, a hemi-ellipsoidal lens or a hemispherical lens. In various embodiments, the optical element may be made from silica, fused silica, soda lime glass, borosilicate glass, sapphire, aluminum nitride, silicone, color glass, IR/UV optical materials (silicon, zinc sulfide, germanium, arsenic trisulfide, barium fluoride, calcium fluoride, magnesium fluoride, zinc selenide), or plastic.

The optical assembly may further include an optical radiation source configured to emit a first optical radiation or an outgoing signal having a first spectral power distribution, and a detector configured to measure a second optical radiation or a returning signal having a second spectral power distribution, wherein the first optical radiation or outgoing signal is incident on the first portion of the curved surface and the second optical radiation or returning signal exits the first portion of the curved surface. The first spectral power distribution may be the same as or different from the second spectral power distribution. The optical assembly may further comprise a reflective surface configured to reflect at least a portion of optical radiation exiting from the second portion of the curved surface and direct it back into the second portion of the curved surface.

The optical assembly may be at least a component of a temperature sensor, a presence sensor, or a distance sensor. The optical assembly may further comprise a sensing element configured to emit the second optical radiation or returning signal, wherein the sensing element comprises a phosphor and the optical assembly is as at least a component of a temperature sensor.

In some embodiments, the optical assembly may further comprise a first optical waveguide having a first end and a second end, wherein the second end is at least partially disposed within the housing, and wherein the first optical waveguide configured to allow a first optical radiation to propagate from the first end to the second end, and allow a second optical radiation to propagate from the second end to the first end, wherein the second end of the first optical waveguide is in optical communication with the first portion of the curved surface. The first optical waveguide may comprise at least one fiber bundle and at least one of an optical rod, a hollow optical rod, a double-clad fiber, a light pipe, a glass rod, or a sapphire rod. At least one of the optical rod, the hollow optical rod, the double-clad fiber, the light pipe, the glass rod, or the sapphire rod may be disposed between the fiber bundle and the optical element. The optical assembly may further include a second optical waveguide that may have the same configuration as the first optical waveguide. The optical assembly may further comprise a rotating joint configured to allow the first optical waveguide to rotate in a plane orthogonal to the first direction of propagation.

In other embodiments, the optical assembly comprises a housing, a first optical waveguide defining a first optical axis, wherein the first optical waveguide includes a first end and a second end, wherein the second end at least partially disposed within the housing. The first optical waveguide may be configured to allow a first optical radiation to propagate from the first end to the second end and to allow a second optical radiation to propagate from the second end to the first end. The optical assembly may further include a first optical port through which the first optical radiation may propagate and a second optical port through which the second optical radiation may propagate. The optical assembly may further include an optical element comprising curved surface and a reflective surface, wherein (i) the second end of the first optical waveguide is in optical communication with a first portion of the curved surface of the optical element, (ii) the first optical port is in optical communication with a first portion of the curved surface of the optical element, (iii) the second optical port is in optical communication with a second portion of the curved surface of the optical element, (iv) at least a portion of the first portion of the curved surface is different from at least a portion of the second portion of the surface, and (v) the optical element is configured to (a) direct the first optical radiation from the first optical waveguide to the second optical port and (b) direct the second optical radiation from the second optical port to the first optical waveguide.

In other embodiments, the optical assembly comprising a housing, a first optical element coupled to the housing and having a first curved surface and a first reflective surface, a second optical element coupled to the housing in optical communication with the first optical element, and having a second curved surface and a second reflective surface. The optical assembly may further include at least one optical waveguide in optical communication with the first optical element and the second optical element, wherein the optical waveguide has a first end, a second end, and a second optical axis, wherein the first optical element is configured to receive a first optical radiation propagating along a first optical axis and to direct the first optical radiation as second optical radiation to the optical waveguide propagating along the second optical axis, wherein the second optical element is configured to receive the second optical radiation from the optical waveguide and direct the second optical radiation as third optical radiation propagating along a third optical axis. The second optical element may be configured to receive a fourth optical radiation propagating along the third optical axis and to direct the fourth optical radiation as fifth optical radiation to the optical waveguide propagating along the second optical axis, wherein the at least one first optical element is configured to receive the fifth optical radiation from the at least one optical waveguide and direct the fifth optical radiation as sixth optical radiation propagating along the first optical axis. In various embodiments, the third optical radiation includes excitation radiation propagating along the third optical axis to a sensing element, and the fourth optical radiation includes fluorescent radiation counter-propagating along the third optical axis. The first optical radiation, the second optical radiation, and the third optical radiation include excitation radiation propagate to a sensing element, and the fourth optical radiation, the fifth optical radiation, and the sixth optical radiation include fluorescent radiation that counter-propagates to a detector. The optical assembly may further comprise an optical radiation source configured to emit the excitation radiation propagating along the first optical axis.

### BRIEF DESCRIPTION OF THE DRAWINGS

Various embodiments of improved optical assemblies and fiber optic sensors will be explained in more detail by way of the accompanying drawings, wherein:

FIG. 1 shows a schematic cross-section view of an embodiment of an optical assembly configured to change the axis of propagation of optical radiation in an optical sensor system.

FIG. 2 shows a schematic cross-section view of an embodiment of an optical assembly.

FIG. 3 shows a schematic cross-section view of an embodiment of an optical assembly.

FIG. 4 shows a schematic cross-section view of an embodiment of an optical assembly.

FIG. 5 shows a schematic cross-section view of an embodiment of an optical assembly.

FIG. 6 shows a schematic cross-section view of an embodiment of an optical assembly.

FIG. 7 shows a schematic cross-section view of an embodiment of an optical assembly.

FIG. 8 shows a schematic cross-section view of an embodiment of an optical sensor system configured to measure at least one property of a target.

FIG. 9 shows a schematic cross-section view of an embodiment of an optical assembly.

FIG. 10 shows a schematic cross-section view of an alternate embodiment of the optical assembly shown in FIG. 9.

FIG. 11 shows a schematic cross-section view of an alternate embodiment of the optical assembly shown in FIG. 9.

FIG. 12 shows a schematic cross-section view of an alternate embodiment of the optical assembly shown in FIG. 9.

FIG. 13 shows a schematic cross-section view of an embodiment of an optical assembly.

FIG. 14 shows a schematic cross-section view of an embodiment of an optical assembly.

FIG. 15 shows an optical schematic of an embodiment of an optical arrangement.

FIG. 16 shows an optical schematic of an embodiment of an optical arrangement.

FIG. 17 shows an optical schematic of an embodiment of an optical arrangement.

FIG. 18 shows an optical schematic of an embodiment of an optical arrangement.

### DETAILED DESCRIPTION

Example embodiments are described herein with reference to the accompanying drawings. Unless otherwise expressly stated, in the drawings the sizes, positions, etc., of components, features, elements, etc., as well as any distances therebetween, are not necessarily to scale, and may be exaggerated for clarity. In the drawings, like numbers refer to like elements throughout. Thus, the same or similar numbers may be described with reference to other drawings even if they are neither mentioned nor described in the corresponding drawing. Also, even elements that are not denoted by reference numbers may be described with reference to other drawings.

The terminology used herein is for the purpose of describing particular exemplary embodiments only and is not intended to be limiting. Unless otherwise defined, all terms (including technical and scientific terms) used herein have the same meaning as commonly understood by one of ordinary skill in the art. As used herein, the singular forms “a,” “an” and “the” are intended to include the plural forms as well, unless the context clearly indicates otherwise. Also, the terms “at least one”, “at least a”, and “one or more” may are intended to include both the singular and plural forms, depending on the context. It should be recognized that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless indicated otherwise, terms such as “first,” “second,” etc., are only used to distinguish one element from another. For example, one coupler could be termed a “first coupler” and similarly, another coupler could be termed a “second coupler”, or vice versa.

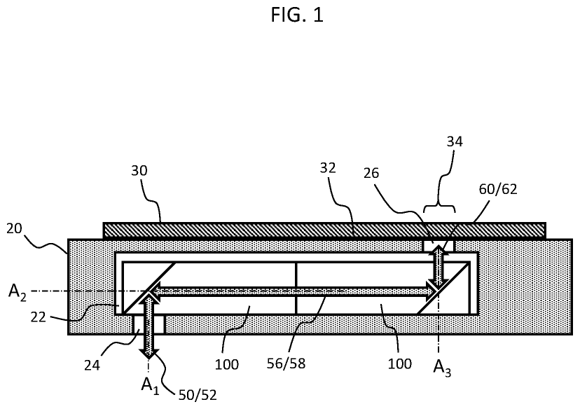

Unless indicated otherwise, spatially relative terms, such as “below,” “beneath,” “lower,” “above,” and “upper,” “opposing,” and the like, may be used herein for ease of description to describe one element or feature's relationship to another element or feature, as illustrated in the FIG. 1t should be recognized that the spatially relative terms are intended to encompass different orientations in addition to the orientation depicted in the FIGS. For example, if an object in the FIGS. is turned over, elements described as “below” or “beneath” other elements or features would then be oriented “above” the other elements or features. Thus, the exemplary term “below” can encompass both an orientation of above and below. An object may be otherwise oriented (e.g., rotated 90 degrees or at other orientations) and the spatially relative descriptors used herein may be interpreted accordingly. A set of reference axes (e.g., X, Y, Z), directions, or coordinates, and the rotation around them (e.g., ex, OY, OZ) may be included in the FIGS. for the purpose of orienting the reader to facilitate understanding of the FIGS. and the specification, and do not necessarily indicate that any particular feature or element is aligned with, or is orthogonal to, any other feature or element.

The paragraph numbers used herein are for organizational purposes only, and, unless explicitly stated otherwise, are not to be construed as limiting the subject matter described. It will be appreciated that many different forms, embodiments and combinations are possible without deviating from the spirit and teachings of this disclosure and so this disclosure should not be construed as limited to the example embodiments set forth herein. Rather, these examples and embodiments are provided so that this disclosure will be thorough and complete, and will convey the scope of the disclosure to those skilled in the art.

Embodiments of the present invention provide new approaches to low-profile optical sensors and optical probes. These approaches address several deficiencies and difficulties present in the current design and manufacture of such sensors probes. Advantageously, a single optical element may be utilized to permit directional changes of the optical axis in a small footprint, thereby providing improved performance in challenging environments (e.g., high optical powers, high operating temperatures, caustic chemical environments) while having designs that simplify the manufacturing process (e.g., by not having tight optical alignment tolerances). For example, by using simple optical elements, internal surfaces of the housing can be used as optical alignment datums). In some embodiments, the optical assemblies may be hermetically sealed or have components that have low outgassing products and may be vacuum compatible. In some embodiments, the optical design takes advantage of inexpensive optical components (e.g., hemispherical lenses) that have high numerical apertures configured to reduce optical fluence and prolong the life of the optical components. A single optical surface can be used so that anti-reflective coatings need only be applied to a single surface, and the surface of the optical components can be used as a protective window, that seals the components of the optical assembly from the ambient environment. Optical materials may be selected so that internal reflection can be used, thereby potentially eliminating the requirement for reflective coatings on some optical surfaces. The embodiments described herein also allow for all components of the optical assembly to be non-metallic, so that they do not affect or disturb the electric fields of the high RF power environment inside the semiconductor process chamber.

FIG. 1 shows a cross-section view of a pair of optical assemblies 100 configured to change the direction of propagation of optical radiation used with a fiber-optic sensor system or other optical sensor system. In various embodiments, the fiber optic sensor system may be used to sense various characteristics or parameters, for example to measure the temperature of a surface 32 of a target 30 (e.g., a semiconductor wafer, electrostatic chuck, or other structure), or to detect the presence or lack of presence of the target 30 where there is little room for an optical probe to be inserted. For example, as shown in FIG. 1, for a particular wafer fabrication process, the temperature of the wafer surface 32 at a specific location 34 must be controlled, but access to that region of the wafer is limited by the design of the wafer support 20. In various embodiments wafer support 20 may be a chuck or an electrostatic chuck. In various embodiments the pair of optical assemblies 100 may be installed in other portions or components within a wafer fabrication equipment chamber, for example an edge ring, shower head or the like. For example, access into the chuck 20 may be limited to a first port 24 formed in the chuck 20 that is laterally offset from a second port 26 formed in the chuck 20, making the placement of a temperature probe difficult. To solve this problem, an optical assembly is required that can direct optical radiation from a first optical axis A₁ to a third optical axis A₃ to provide optical access to the location 34, wherein the third optical axis A₃ is parallel to but offset from the first optical axis A₁. Such an optical assembly may be positioned within a cavity 22 formed in the chuck 20. In some embodiments, optical radiation 50 (also referred to herein as “excitation radiation 50”) contains wavelengths operative to excite a sensing element (e.g., a phosphor) in thermal communication with the surface 32. The excitation radiation 50 (e.g., from a light source such as an LED or laser) propagating along the first optical axis A₁ through the first port 24 into a first optical assembly 100, where it is directed as excitation radiation 56 propagating along a second optical axis A₂ and enters the second optical assembly 100, where it is directed as excitation radiation 60 along the third optical axis A₃ to a sensing element (not shown for clarity in FIG. 1). When the sensing element is provided as a phosphor, the excitation radiation 60 causes the phosphor to fluoresce, and at least a portion of the fluorescent radiation is directed back along the third optical axis A₃ as counter-propagating fluorescent radiation 62, where it enters the second optical assembly 100 and is directed as counter-propagating fluorescent radiation 58 propagating along the second optical axis A₂ to the first optical assembly 100, where it is directed as counter-propagating fluorescent radiation 52 back along the first optical axis A₁ propagating through the first port 24, to other parts of the optical sensor configured to measure the properties of the counter-propagating fluorescent radiation 52 to in order to measure the temperature or other characteristics of the surface 32 at the location 34.

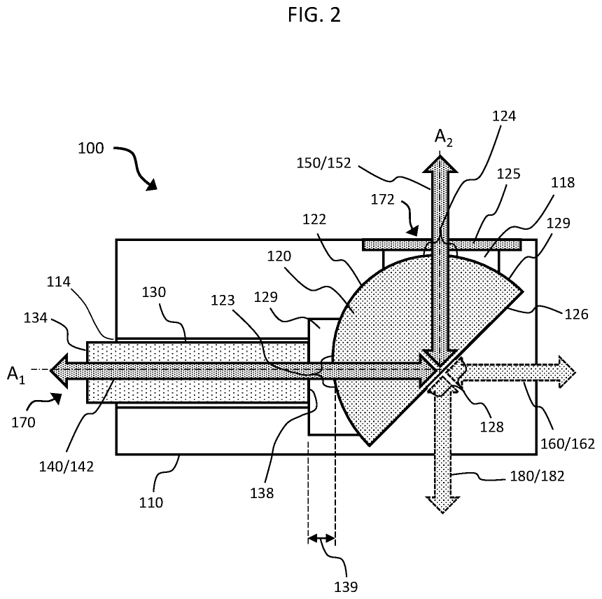

FIG. 2 shows a cross-section view of an example embodiment of an optical assembly 100 for use in an optical sensor or optical sensor system. The optical assembly 100 may be used as a component of a distance sensor, a presence sensor, an edge finder, a temperature sensor, an optical spectrum sensor, or any of a wide variety of sensor or sensor system. In the illustrated embodiment, the optical assembly 100 has a first optical port 170 configured to allow optical radiation to propagate bidirectionally therethrough and a second optical port 172 configured to allow optical radiation to propagate bidirectionally therethrough. For example, optical radiation 140 may propagate through the optical port 170 toward an optical element 120, and optical radiation 142 (also referred to herein as “counter-propagating radiation 142”) may propagate from the optical element 120 to the first optical port 170. The double-ended block arrows indicate the optical radiation 140 propagating in a first direction and the counter-propagating radiation 142 propagating in the opposite direction. This convention will be used throughout the present disclosure to indicate radiation and counter-propagating radiation pairs 150/152, 160/162, 180/182, 250/252, and so on throughout this Detailed Description. Generally, the radiation 140 and the counter-propagating radiation 142 are described as propagating along the optical axis A₁, but those skilled in the art will appreciate that the radiation 140 and the counter-propagating radiation 142 may also propagate parallel to but offset from the optical axis A₁. This also applied to radiation and counter-propagating radiation propagating along optical axes A₂ and A₃. Also, those skilled in the art will appreciate that the optical radiation may not propagate exactly parallel to the optical axes, but may propagate by total internal reflection within the various waveguides or optical fibers.

In the embodiment shown in FIG. 2, the optical assembly 100 is configured to change the direction of propagation of optical radiation at an angle of approximately 90 degrees, though in other embodiments described in more detail below, the optical assembly 100 may be configured to change the direction of propagation of optical radiation at angles less than or greater than 90 degrees.

The optical assembly 100 includes at least one housing 110 having a first opening or passage 114 and a second opening or passage 118 formed therein. An optical element-receiving passage or relief 119 configured to accept at least one optical element 120 disposed at least partially within the relief 119 is formed in the housing 110. In various embodiments, the optical element-receiving passage or relief 119 is configured as a surface that passively optically aligns the optical element 120 with respect to other features or optical element used in the optical assembly 100. In the illustrated embodiment, the passage 118 is a circular opening formed adjacent to the optical element 120. An internal relief 129 may also be formed in the housing 110. The housing 110 may be formed from any of a wide variety of materials, including, without limitation, metals (aluminum, copper or copper-based alloys (brass, bronze) stainless steel, nickel-based alloys (Kovar, Invar, Inconel), Tungsten Carbide, Copper Tungsten), optical materials (glass, Zerodur), ceramics, plastics, and composite materials (phenolic, fiberglass, carbon fiber). Those skilled in the art will appreciate that the housing 110 may be formed from any variety or combination of materials. FIG. 2 shows the housing 100 as having a rectangular prism shape, though those skilled in the art will appreciate that the housing 100 may have different shapes. In the illustrated embodiment, the housing 100 is a one-piece housing, though in other embodiments the housing 100 may include more than one piece. Owing to the compact design of the optical assembly 100, in one embodiment, the dimension of the housing 110 perpendicular to the first direction of propagation may be about 6 mm or less. In other embodiments, the dimension of the housing 110 perpendicular to the first direction of propagation may be 3 mm or less.

At least one optical element 120 having a first surface 122 with a surface portion 123 and a surface portion 124, and having a second surface 126 having a surface portion 128 is positioned in the housing 110. In the illustrated embodiment, the first surface 122 is curvilinear (also referred to herein as a “curved surface”). As such, the surface portions 123 and 124 are likewise curved. The surface portions 123 and 124 are configured to allow optical radiation to pass therethrough. The second surface 126 is configured to reflect the optical radiation entering the surface portion 123 toward the surface portion 124, and vice versa. In the illustrated embodiment, the second surface 126 is oriented at an angle of approximately 45 degrees relative to the direction of propagation of the optical radiation entering and leaving the optical assembly 100. In one embodiment, the optical element 120 has a focal length suited to focus the beam at a prescribed distance from the surface 122. In one embodiment, the focal length of the optical element 120 is between 1 millimeter and 350 millimeters. In the illustrated embodiment, though not shown, the second surface 126 is spaced apart from the structure of the housing 110, leaving an air gap between the housing 110 and the second surface 126. When configured as such, the second surface 126 is configured to internally reflect optical radiation (e.g., by virtue of a difference in refractive index of the optical element 120 and the air in the gap between the housing 110 and the second surface 126). When configured as such, the second surface 126 may also be referred to herein as “the internal reflection surface 126”. In other embodiments, the second surface 126 may be coated with a reflective material or reflecting layer (not shown) having a reflectance chosen to reflect a percentage of the optical radiation incident thereon. In various embodiments, the reflective layer may be provided as a dichroic mirror, a total internal reflective mirror, at least one metal film, or at least one dielectric film or coating. The percentage of reflected optical radiation may be anywhere from 1% to 100%. In still other embodiments, at least a portion of the second surface 126 may include a dichroic mirror. In various embodiments, such a dichroic mirror may be configured to substantially transmit a selection of wavelengths of the total optical radiation incident on the second surface 126 and to substantially reflect a selection of wavelengths of the total optical radiation incident on the second surface 126. Though the optical element 120 is shown as a single optical element, those skilled in the art will appreciate that the optical element 120 may include a plurality of optical elements arranged in any of a wide variety of configurations. The material of the optical element 120 may be chosen to have a specific percentages of transmission of optical radiation at various wavelengths. For example, the optical element 120 may have a transmissivity at one or more wavelengths of 50% or greater, depending on the material used.

As shown in FIG. 2, the optical radiation entering the optical element 120 reflects from a reflective surface portion 128 of the second surface 126. When configured as shown in FIG. 2, the surface portion 128 is configured to reflect or direct optical radiation bidirectionally. In the illustrated embodiment, the optical element 120 is provided as a hemispherical lens wherein the surface portion 123 and the surface portion 124 are a portion of a spherical surface. Those skilled in the art will appreciate that the optical element 120 may be provided as any of a variety of shapes or types of lenses, including, without limitation, ball lenses, half-ball lenses, elliptical lenses, hemispherical prism lenses, aspherical lenses, hyper-hemispherical lenses, hypo-hemispherical lenses, hemi-ellipsoidal lenses, GRIN lenses, planar mirrors, waveplates, beamsplitters, prisms, diffraction gratings, Fresnel lenses, and the like or any combination thereof. As such, the surfaces 122 and 126 may be formed in a manner consistent with the shapes or types of lenses described above. In various embodiments, the optical element 120 may be formed from a variety of materials, including, without limitation, glass, sapphire, plastic, silicon carbide, fused silica, silicone (RTV), color glass, and IR/UV optical materials such as Silicon, Zinc Sulfide, Germanium, Arsenic Trisulfide, Barium Fluoride, Calcium Fluoride, Magnesium Fluoride, Zinc Selenide or the like or any combination thereof. Those skilled in the art will appreciate that the optical element 120 may be formed from any variety of optical materials.

The first surface 122 (including the surface portion 123 and surface portion 124) of the optical element 120 may be coated with at least one optical coating configured to reduce back-reflection, increase transmissivity, increase the laser-induced damage threshold (LIDT) or affect any other optical property. In other embodiments, all or a portion of the first surface 122 may be coated with a reflective coating having a reflectance of at least 50%, or at least 75%, or at least 90% to a wavelength of light that is directed through optical assembly 100. The coatings may be applied to the first surface 122 by any variety of process, including, without limitation, physical vapor deposition, chemical vapor deposition, sputtering, or the like. When provided as a reflective coating, the coating may include, consist essentially of a single layer, for example aluminum, chromium, silver, gold, nickel, dielectric films such as silicon dioxide, silicon nitride, magnesium fluoride or the like, or may include multiple layers, or a Bragg reflector. When provided as an anti-reflective coating, the coating may include a nanotextured surface comprising nanowires, microwires, nanocones, nanodomes and nanopillars applied by a variety of processes, including electron beam lithography, chemical etching, vapor-liquid solid growth, spin coating or dip coating. Such a nanotextured coating or surface may be formed by laser patterning, selective laser ablation or other forms of laser material processing or other types of processing, for example, chemical vapor deposition. In other embodiments, the coating of the first surface 122 includes at least one interferometric structure, layer or coating configured to filter or remove at least a portion of a wavelength of light that is directed through optical assembly 100. When applied as such, the layer or coating may be configured to act as a band pass filter, high pass filter, low pass filter, notch filter or having any arbitrary filter characteristic, to a wavelength of light that is directed through the optical assembly 100. In still other embodiments, at least a portion of the first surface 122 may include a dichroic mirror. In various embodiments, such a dichroic mirror may be configured to substantially transmit a selection of wavelengths of the total optical radiation incident on the first surface 122 and to substantially reflect a selection of wavelengths of the total optical radiation incident on the first surface 122. In various embodiments, the optical element 120 may be configured for total internal reflection of light from at least a portion of the internal reflective surface 126. Those skilled in the art will appreciate that the first surface 122 may be coated with any of a wide variety of optical coatings. The second surface 126 may include at least one interferometric structure, layer or coating configured as a band pass filter, a low pass filter, a notch filter, a high pass filter or having any arbitrary filter characteristic, to a wavelength of light that is directed through the optical assembly 100. Those skilled in the art will appreciate that the second surface 126 may be provided as or with any of the materials, coatings, structures and the like as the first surface 122.

The passage 114 is configured to receive an optical waveguide 130 configured to guide the optical radiation 140 from the first optical port 170 to the optical element 120 and from the optical element 120 to the first optical port 170. The waveguide 130 has a first end 134 defining the first optical port 170 and a second end 138, defining a first optical axis A₁. In the illustrated embodiment, the waveguide 130 is provided as a single-clad optical fiber having a core and a cladding, wherein the core has a first diameter and the optical element 120 has a radius wherein the ratio of the core diameter to the lens radius is 10 or more. In various embodiments, the first end 134 and the second end 138 of the waveguide 130 are coated with anti-reflective coatings operative to minimize back-reflection from either surface. Alternatively, the first end 134 and the second end 138 may be uncoated or may be formed at an angle to reduce back-reflection. In the illustrated embodiment, the second end 138 of the waveguide 130 may be spaced apart from the surface 122 of the optical element 120 by a distance 139 formed in a relief 129. In various embodiments, the distance 139 may be less than about 20 mm, or less than about 10 mm, or less than about 5 mm, or less than about 2 mm. The relief 129 may be filled with air or other gas, an index matching fluid, or an index matching adhesive. In other embodiments, the waveguide 130 may be provided as any variety of optical waveguide (e.g., optical rods, hollow optical rods, double-clad fibers, optical fiber bundles, light pipes, single-crystal fibers, photonic crystal fibers, sapphire rods, homogenizers, or the like or any combination thereof). In one embodiment, the waveguide 130 has an optical transmittance of greater than 40%, though those skilled in the art will appreciate that the waveguide 130 may have an optical transmittance of any amount or percentage. The waveguide 130 may be retained in the passage 114 by an adhesive or other retention device or method. In various embodiments, a homogenizer may act to randomize or partially randomize the direction and or angle of light rays exiting the homogenizer (e.g., by scattering), with respect to how they entered the homogenizer. In various embodiments, such a homogenizer may include a solid optical rod, a light pipe, or the like. Those skilled in the art will appreciate that a variety of optical devices may be used as a homogenizer.

In various embodiments, to protect the components of the optical assembly 100 from the harsh environment of the process chamber, a protective window 125 may be inserted into the passage 118 and secured in place (e.g., mechanically, or with one or more adhesives or other means of fixturing). The window 125 may be provided as a planar optic or a lens formed of any of the optical materials listed herein with respect to the optical element 120. Those skilled in the art will appreciate that the protective window 125 is optional.

When the optical assembly 100 is configured as shown in FIG. 2, the optical radiation 140 is confined to the waveguide 130 until it exits the second end 138 of the waveguide 130. As the optical radiation 140 enters the free space of the relief 129 (e.g., when the relief 129 is filled with a gas such as air), the optical radiation 140 may begin to diverge. The optical radiation 140 is then collimated by the optical element 120, and is focused by the optical element 120 as it exits through the surface portion 124 and propagates through the second optical port 172 as optical radiation 150 along an optical axis A₂. Counter-propagating radiation 152 enters the optical port 172 and is directed into the waveguide 130 by the optical element 120 as counter-propagating radiation 142 that propagates through the first optical port 170.

In the illustrated embodiment, the optical assembly 100 is configured such that optical radiation 140 (e.g., light having one or more wavelengths propagating from a source (not shown)) enters the first optical port 170 and is incident on a first portion 123 of the surface 122, reflects off the portion 128 of the internal reflective surface 126 and exits the optical element 120 through a second portion 124 of the surface 122 the second optical port 172. The passage 118 is configured to allow optical radiation exiting through the second portion 124 of the curved surface 122 to exit the housing 110. The passage 118 may be filled with air or other gas, an index matching fluid, or an index matching adhesive. In one example embodiment, when the optical assembly 100 is used with a thermographic fiber-optic sensor system (e.g., to measure the temperature of the surface 32 of the target 30 shown in FIG. 1), the optical radiation 140 (also referred to herein as “excitation radiation 140”) contains wavelengths operative to excite a sensing element (e.g., a thermographic phosphor). The excitation radiation 140 (e.g., from an optical radiation source such as an LED or laser) enters the first optical port 170, propagates through the waveguide 130, enters the optical element 120 through the surface portion 123 of the surface 122, reflects off of the surface portion 128 of the internal reflection surface 126, propagates through the surface portion 124 of the surface 122, through the window 125, thereby exiting the second optical port 172 as excitation radiation 150, whereupon it propagates to the sensing element and excites the phosphor. As the phosphor luminesces (also referred to herein as “fluoresces”), luminescent radiation (also referred to herein as “emitted radiation” or “fluorescent radiation”) containing information related to the temperature of the sensing element propagates back toward the optical assembly 100 as emitted counter-propagating radiation 152 that enters the second optical port 172, propagates through the surface portion 124 of the surface 122, reflects off of the surface portion 128 of the internal reflection surface 126, exits the optical element 120 through the surface portion 123 and propagates through the waveguide 130 as emitted counter-propagating radiation 142 that exits the first optical port 170 where it is routed to other parts of the fiber-optic sensor system (e.g., to a detector configured to measure a characteristic of the counter-propagating radiation 142 containing information related to the temperature, for example the rate of intensity decay of the emitted counter-propagating radiation 142). In the illustrated embodiment, the emitted counter-propagating radiation 142/152 has different spectral power distribution than the excitation radiation 140/150.

In other embodiments, when the optical assembly 100 is used as a position sensor or a presence sensor, instead of a temperature sensing element, the radiation 150 may be incident on a test surface spaced apart from the optical assembly 100, for example, in the direction of axis A₂. In various embodiments, the radiation 150 may be reflected when the test surface is aligned with axis A₂, in which case counter-propagating radiation 152/142 may be detected at the first optical port 170. However, if the test surface is not aligned with axis A₂, the radiation 150 does not hit and/or reflect off of the test surface, no counter-propagating radiation 152/142 would be detected at the first optical port 170. In various embodiments, the presence of a counter-propagating radiation 142 at the first optical port 170 may provide a signal related to the presence or absence of the test surface above the optical assembly 100. In some position sensing or presence sensing embodiments, the spectral power distribution of the radiation 140/150 may be the same or similar to that of the counter-propagating radiation 152/142. In various embodiments, position sensing or presence sensing may be accomplished by using one or more sensors and noting the time when a return or counter-propagating signal is present and absent. This will provide information regarding the position or presence of a test surface relative to the position of the one or more sensors.

In other embodiments, the internal reflection surface 126 may be provided as a dichroic mirror or is coated with a dielectric coating that allows a portion of the optical radiation 140 to propagate through the surface 126 as transmitted radiation 160 (e.g., to be measured by an optical detector (not shown)), and counter-propagating radiation 162 can propagate into the optical assembly 100, through the surface 126, and exit the first optical port 170. In similar fashion, a portion of the counter-propagating radiation 152 may propagate through the surface 126 as transmitted radiation 180 (e.g., to be measured by an optical detector (not shown)), and counter-propagating radiation 182 can propagate into the optical assembly 100, through the surface 126, and exit the second optical port 172.

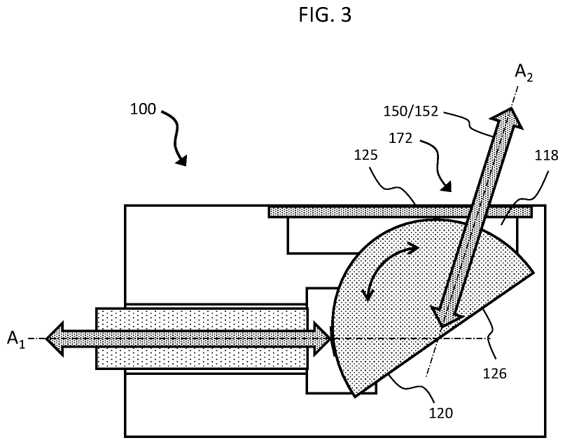

FIG. 3 shows a cross-section view of an example embodiment of the optical assembly 100 configured to change the direction of propagation of the optical radiation 150/152 along the optical axis A₂ at an angle of greater than 90 degrees relative to the optical axis A₁. The optical assembly 100 is provided as described above with respect to FIG. 2, except that the second surface 126 of the optical element 120 is positioned at a different angle, and the passage 118 and the window 125 may be larger and/or may be positioned in a location to allow the optical radiation 150/152 to exit and enter the second optical port 172 of the optical assembly 100 along the optical axis A₂ at the angle shown. In the illustrated embodiment, the optical element 120 (and, thereby, the angle of the second surface 126) is fixed at the angle shown, but in other embodiments, the angular orientation of the optical element 120 can be adjustable. Though not shown, in another embodiment, similar to FIG. 2, the second surface 126 may be provided as a dichroic mirror.

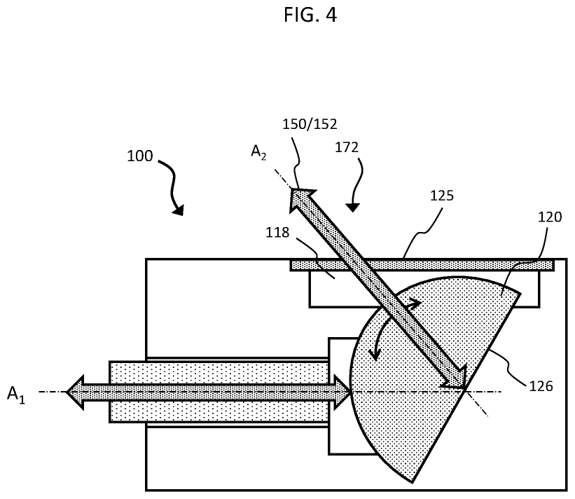

FIG. 4 shows a cross-section view of an example embodiment of the optical assembly 100 configured to change the direction of propagation of the optical radiation 150/152 along the optical axis A₂ at an angle of less than 90 degrees relative to the optical axis A₁. The optical assembly 100 is provided as described above with respect to FIG. 3, except that the second surface 126 of the optical element 120 is positioned at a different angle, and the passage 118 and the window 125 may be large enough and/or positioned in a location to allow the optical radiation 150/152 to exit and enter the second optical port 172 along the optical axis A₂ at the angle shown. In the illustrated embodiment, the optical element 120 is fixed at the angle shown, but in other embodiments, the angular orientation of the optical element 120 can be adjustable. Though not shown, in another embodiment, similar to FIG. 2, the second surface 126 may be provided as a dichroic mirror.

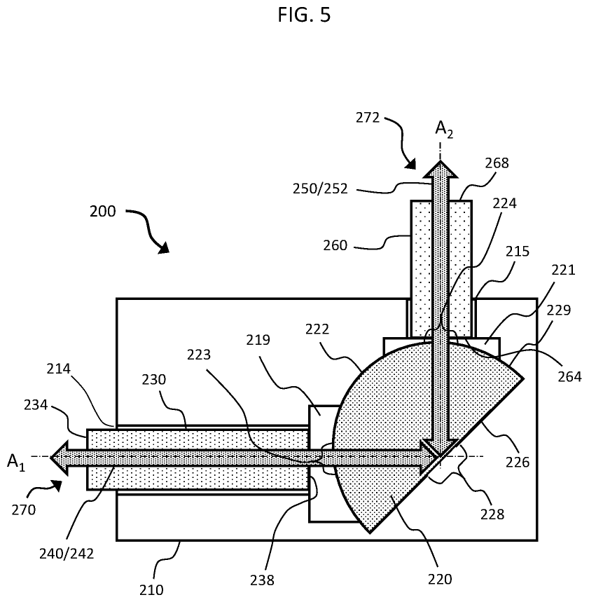

FIG. 5 shows a cross-section view of an example embodiment of an optical assembly 200. The optical assembly 200 may be used as a component of a distance sensor, a presence sensor, an edge finder, a temperature sensor, an optical spectrum sensor, or any of a wide variety of sensors or sensor systems. The structure of the optical assembly 200 is similar to the optical assembly 100 described above. The optical assembly 200 includes at least one housing 210 having a first opening or passage 214 sized to receive a first optical waveguide 230, and a second opening or passage 215 sized to receive a second optical waveguide 260 therein. Internal reliefs 219 and 221 are also formed in the housing 210. An optical element-receiving passage or relief 229 configured to accept at least one optical element 220 is formed in the housing 210. The optical assembly 200 is configured to change the direction of propagation of optical radiation 240 propagating along a first optical axis A₁ to propagating as optical radiation 250 along a second optical axis A₂ (and the same in reverse for counter-propagating optical radiation 252 to counter-propagating optical radiation 242) as described herein. While FIG. 5 shows the angle between the first optical axis A₁ and the optical axis A₂ as 90 degrees, the optical assembly 200 may be configured to change the direction of propagation of optical radiation at any angle and optionally may be configured such that the angle is adjustable.

The optical assembly 200 has a first optical port 270 and a second optical port 272. The first waveguide 230 has a first end 234 and a second end 238 together defining the first optical port 270 and the first optical axis A₁. The second waveguide 260 includes a first end 264 and a second end 268 defining the second optical axis A₂. The first waveguide 230 is configured to guide the optical radiation 240 from the first optical port 270 to the optical element 220. The optical element 220 receives, reflects and optionally focuses the optical radiation 240 as optical radiation 252 coupled into the second waveguide 260 where it propagates through the second waveguide 260 along the second optical axis A₂ until it exits the second optical port 272. Counter-propagating radiation 252 enters second optical port 272 where it propagates through the waveguide 260 along the optical axis A₂ to the optical element 220, where it is reflected and optionally focused into the first optical waveguide 230 as counter-propagating optical radiation 242 that propagates along the first optical axis A₁ until it exits the first optical port 270. In various embodiments, the optical element 220 and waveguides 230 and 260 may be provided as described above with respect to the optical element 120 and the optical waveguide 130 (along with any and all of the alternatives, configurations, variations, and combinations thereof). Also, other structures or features of the optical assembly 200 may be provided in similar fashion as those described above with respect to the optical assembly 100 (along with any and all of the alternatives, configurations, variations, and combinations thereof).

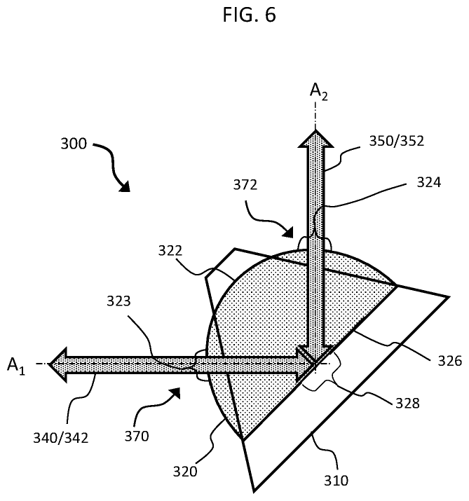

FIG. 6 shows a cross-section view of an example embodiment of an optical assembly 300. The optical assembly 300 may be used as a component of a distance sensor, a presence sensor, an edge finder, a temperature sensor, an optical spectrum sensor, or any of a wide variety of sensors or sensor systems. Some of the structure of the optical assembly 300 is similar to the optical assemblies 100 and 200 described above. The optical assembly 300 is configured to change the direction of propagation of optical radiation 340 propagating along a first optical axis A₁ to propagating as optical radiation 350 along a second optical axis A₂ (and the same in reverse for counter-propagating optical radiation 352 to counter-propagating optical radiation 342) as described herein. While FIG. 6 shows the angle between the first optical axis A₁ and the second optical axis A₂ as 90 degrees, the optical assembly 300 may be configured to change the direction of propagation of optical radiation at any angle.

The optical assembly 300 includes at least one housing 310 and at least one optical element 320. The optical element 320 includes a first surface 322, first surface portion 323, a second surface portion 324, a second reflecting surface 326 with a reflecting region 328. The optical assembly 300 has a first optical port 370 (the first surface portion 323) and a second optical port 372 (the second surface portion 324). The optical element 320 receives and reflects optical radiation 340 propagating along a first optical axis A₁ as optical radiation 350 that propagates along a second optical axis A₂ through the second optical port 372. Counter-propagating radiation 352 enters second optical port 372 along the optical axis A₂ to the optical element 320, where it is reflected as counter-propagating optical radiation 342 that propagates along the first optical axis A₁, exiting the first optical port 370. In various embodiments, the optical element 320 may be provided as described herein with respect to the optical elements 120 and 220 (along with any and all of the alternatives, configurations, variations, and combinations thereof). Also, other structures or features of the optical assembly 300 may be provided in similar fashion as those described herein with respect to the optical assemblies 100 and 200 (along with any and all of the alternatives, configurations, variations, and combinations thereof).

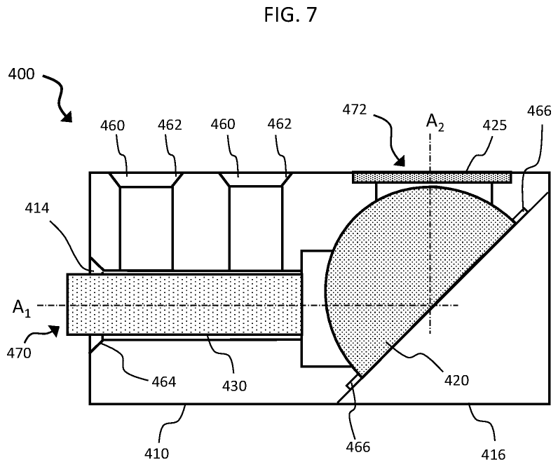

FIG. 7 shows a section view of an example embodiment of an optical assembly 400. The optical assembly 400 may be used as a component of a distance sensor, a presence sensor, an edge finder, a temperature sensor, an optical spectrum sensor, or any of a wide variety of sensors or sensor systems. Some of the structure of the optical assembly 400 is similar to the optical assemblies 100 and 200 described above. The optical assembly 400 incorporates several features configured to make manufacturing of the optical assembly 400 easier or less expensive than the other embodiments described herein. These features include a two-piece housing (including a housing portion 410 and a housing portion 416), a countersink 464 formed at the opening of a passage 414 configured to facilitate insertion of an optical waveguide 430 into the passage 414. A plurality of adhesive ports 460 may be formed in the housing portion 410, each adhesive port 460 including an optional chamfer 462. The adhesive ports 462 may be used for introduction of adhesive to secure the optical waveguide 430 in the passage 414. In various embodiments, the optical assembly 400 may be constructed by positioning or adhering the optical element 420 within the housing portion 410 and covering or holding the optical element 420 in place with the housing portion 416. In the illustrated embodiment, counterbore regions 466 are formed around the periphery of the optical element 420 in the housing portion 410 to create a channel to control the amount of adhesive used to optionally adhere the optical element 420 to the housing portion 410. In various embodiments the housing portion 416 may be formed from sheet metal, machined metal or other housing materials mentioned herein.

Those skilled in the art will appreciate that, in various embodiments, the optical element 420, the waveguide 430, and the optional window 425, and their orientation relative to the optical axes A₁ and A₂ may be provided as described herein with respect to the optical elements 120, 220, and 320 and the optical waveguides 130, 230, and 330, respectively (along with any and all of the alternatives, configurations, variations, and combinations thereof). Also, other structures or features of the optical assembly 400 may be provided in similar fashion as those described herein with respect to the optical assemblies 100, 200, and 300 (along with any and all of the alternatives, configurations, variations, and combinations thereof).

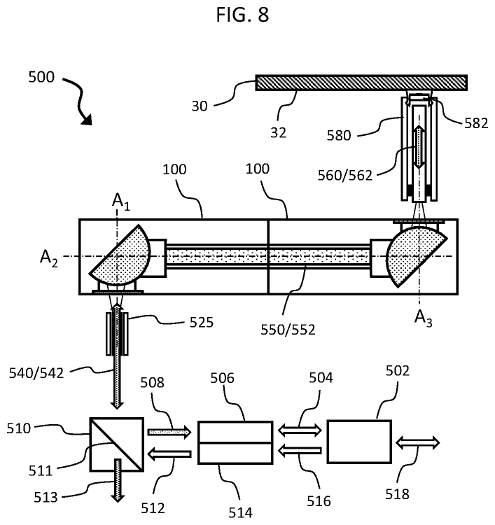

FIG. 8 shows an example embodiment of an optical sensor system 500 configured to sense and measure at least one property of a target surface 32 of a target 30 (e.g., a semiconductor wafer, wafer holder, or other portions of wafer fabrication or other equipment). The optical sensor system 500 includes a processing unit 502 and an optical radiation source 506 in communication with the processing unit 502 via a communication link 504, wherein the optical radiation source 506 is configured to emit an outgoing optical radiation or signal 508 (e.g., an optical excitation signal, for example, configured to cause luminescence of a phosphor sensing element) routed to a pair of optical assemblies 100 via an optical link 525. The optical radiation source 506 may be provided as an LED, a super-luminescent diode (SLED), a laser, or a broadband light source. Those skilled in the art will appreciate that the optical radiation source 506 may be provided as any of a wide variety of light sources. The optical sensor system 500 further includes a detector 514 configured to measure one or more properties of a returning radiation or signal 512 and send measurement data representative of those properties to the processing unit 502 via a communications link 516. The processing unit 502 is configured to provide commands to the optical radiation source 506 (e.g., to emit the excitation signal 508) and receive, amplify or otherwise process the returning signal 512 from the detector 514 to determine the measurement results (e.g., the temperature of the surface 32), and either display the results, or transmit them to another instrument or control system, via a communications link 518.

In the illustrated embodiment, the optical sensor system 500 further includes an optical element 510 configured to direct the optical signal 508 to the optical assemblies 100 via the optical link 525, and to direct the returning signal to a detector 514 instead of the optical radiation source 506 (e.g., to prevent harmful optical feedback effects). In the illustrated embodiment, the optical element 510 is an optical splitter having a partially reflective surface 511 formed therein. In some embodiments, when the optical element 510 is provided as an optical splitter, the surface 511 may allow a portion of counter-propagating radiation (e.g., at a particular wavelength, range of wavelengths, or optical powers) to pass through the partially reflective surface 511 as radiation 513, for a variety of purposes. In other embodiments, the optical element 510 may be provided as an optical circulator.

The optical signal 508 is routed through the optical link 525 to the optical assemblies 100 as radiation 540 propagating along the optical axis A₁. The optical assemblies 100 assembled together as shown are configured to change the direction of propagation of the radiation 540 (containing the optical signal 508) propagating along a first optical axis A₁ to propagating along a third optical axis A₃ that is substantially parallel to but offset (also referred to herein as “off-axis”) from the first optical axis A₁, thereby routing the radiation 540 as radiation 560 (containing the signal 508) to a sensing element 582 of an optical probe 580, wherein the sensing element 582 is in thermal communication with the surface 32 of the target 30.

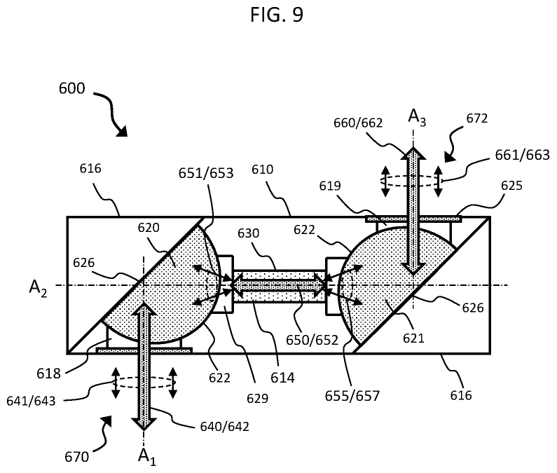

In other embodiments, the first optical axis A₁ may not be parallel to the third optical axis A₃. Also, the pair of optical assemblies 100 may be configured to change the direction of propagation of the radiation 540 at any angle. The optical assemblies 100 may be provided as any of the embodiments of the optical assemblies 100, 200, 300 or 400 described herein with respect to FIGS. 2-7. In other embodiments, the optical assemblies 100 may be provided as any of the embodiments of the optical assemblies 600, 700, or 800 described herein with respect to FIGS. 9-14.

When the sensing element 582 is provided as a phosphor, the signal 508, the radiation 540, 550, and 560 are provided as excitation radiation incident on the sensing element 582 that absorbs at least a portion of the radiation 560 and emits fluorescent radiation (e.g., that will ultimately be measured as the return signal 512 by the detector 514) as counter-propagating fluorescent radiation 562 propagating back along the optical axis A₃, where it is reflected as fluorescent counter-propagating optical radiation 552 propagating along optical axis A₂, where it is reflected and propagates as fluorescent counter-propagating radiation 542 along the optical axis A₁, where it is coupled into the optical link 525 and back to the optical element 510, where it is directed to the detector 514. Generally, the excitation radiation and the fluorescent radiation have different optical power spectral distributions and different frequency content. In various embodiments, the counter-propagating signal may also include a portion of the excitation radiation, that, in various embodiments may be separated from the fluorescent radiation.

FIG. 9 shows a cross-section view of an example embodiment of an optical assembly 600. The optical assembly 600 may be used as a component of a distance sensor, a presence sensor, an edge finder, a temperature sensor, an optical spectrum sensor, or any of a wide variety of sensors or sensor systems. In the illustrated embodiment, the optical assembly 600 is configured to change the direction of propagation of optical radiation propagating along a first optical axis A₁ to propagating along a third optical axis A₃ that is parallel to but offset (also referred to herein as “off-axis”) from the first optical axis A₁. In the illustrated embodiment, the optical assembly 600 includes a first housing portion 610 and two second housing portions 616. A passage 614 is formed in the first housing portion 610, wherein the passage 614 is sized to receive at least one optical waveguide 630. The optical waveguide 630 may be provided as the waveguide 130 described above with respect to FIG. 2, or with similar characteristics. The first housing portion 610 includes a first optical port 670 defined by a passage 618 formed in the housing 610, and second optical port 672 defined by a second passage 619 formed in the first housing portion 610. In the illustrated embodiment, the second housing portions 616 are coupled to the housing 610, though the housing portions 616 may be formed monolithically with the first housing portion 610. In the illustrated embodiment, optional protective windows 625 may be secured to the passages 618 and 619 (in similar fashion to the window 125 described above with respect to FIG. 1). Two reliefs 629 are formed in the housing 610, each relief adjacent to corresponding optical elements 620 and 621. While FIG. 9 shows first optical axis A₁ as parallel to third optical axis A₃, in other embodiments first optical axis A₁ may not be parallel to third optical axis A₃.

The first optical element 620 and the second optical element 621 (having refractive surfaces 622 and reflective surfaces 626) are secured within the housing 610 or to the additional housing portions 616. The optical elements 620 and 621 may be provided as any of the optical configurations, shapes, surfaces, materials, coatings, and the like that are described herein with respect to the optical element 120. In the illustrated embodiment, the optical elements 620 and 621 are identical, though those skilled in the art will appreciate that the optical elements 620 and 621 may not be identical.

The optical assembly 600 is configured to receive optical radiation 640 propagating into the first optical port 670 along the first optical axis A₁ into the first optical element 620, reflecting off of the reflective surface 626 and being coupled into the optical waveguide 630, propagating through the optical waveguide 630 along a second optical axis A₂ as optical radiation 650, into the second optical element 620, where it is reflected from the reflective surface 626 and exits through the second optical port 672 as optical radiation 660 propagating along the third optical axis A₃. The optical assembly 600 is also configured to receive counter-propagating radiation 662 propagating through the second optical port 672 along the third optical axis A₃, into the second optical element 620, where it is reflected from the reflective surface 626 and propagates through the waveguide 630 along the optical axis A₂, through the optical element 620, where it is reflected by the reflective surface 626 and propagates out of the first optical port 670 along the optical axis A₁ as optical radiation 642. FIG. 9 shows the change in orientation of the optical axes A₁/A₂ and A₂/A₃ as 90 degrees each, but these axes may be oriented at any angle with respect to each other (similar to as shown in FIGS. 3 and 4). In one embodiment, the angle between the optical axis A₁ and the optical axis A₂ is between 10° and 170°. In another embodiment, the angle between the optical axis A₁ and the optical axis A₂ is between 20° and 160°. In another embodiment, the angle between the optical axis A₁ and the optical axis A₂ is between 30° and 150°. In another embodiment, the angle between the optical axis A₁ and the optical axis A₂ is between 40° and 130°. In another embodiment, the angle between the optical axis A₁ and the optical axis A₂ is between 50° and 120°. In another embodiment, the angle between the optical axis A₁ and the optical axis A₂ is between 60° and 110°. In another embodiment, the angle between the optical axis A₁ and the optical axis A₂ is between 70° and 100°. In another embodiment, the angle between the optical axis A₁ and the optical axis A₂ is between 80° and 90°.

In one embodiment, the angle between the optical axis A₂ and the optical axis A₃ is between 10° and 170°. In another embodiment, the angle between the optical axis A₂ and the optical axis A₃ is between 20° and 160°. In another embodiment, the angle between the optical axis A₂ and the optical axis A₃ is between 30° and 150°. In another embodiment, the angle between the optical axis A₂ and the optical axis A₃ is between 40° and 130°. In another embodiment, the angle between the optical axis A₂ and the optical axis A₃ is between 50° and 120°. In another embodiment, the angle between the optical axis A₂ and the optical axis A₃ is between 60° and 110°. In another embodiment, the angle between the optical axis A₂ and the optical axis A₃ is between 70° and 100°. In another embodiment, the angle between the optical axis A₂ and the optical axis A₃ is between 80° and 90°.

To illustrate at least some of the optical effects of the optical assembly 600, the optical radiation 640 is shown by individual rays 641 entering the first optical port 670 as collimated rays that are then focused and/or coupled by the optical element 620 into the optical waveguide 630, shown as rays 651. As the optical radiation 650 exits the optical waveguide 630 into the free space of the relief 629, they begin to diverge as shown by rays 655, and are then collimated by the optical element 620 and exit the second optical port 672 as collimated rays 661. The optical effects of the optical assembly 600 are also shown in reverse, as the counter-propagating radiation 662 enters the second optical port 672 as collimated rays 663 that are reflected and coupled by the optical element 620 into the optical waveguide 630, shown as rays 657 that upon exiting the waveguide 630, shown as rays 653, where they are reflected and propagate through the optical port 670, shown as collimated rays 643 propagating along the first optical axis A₁.

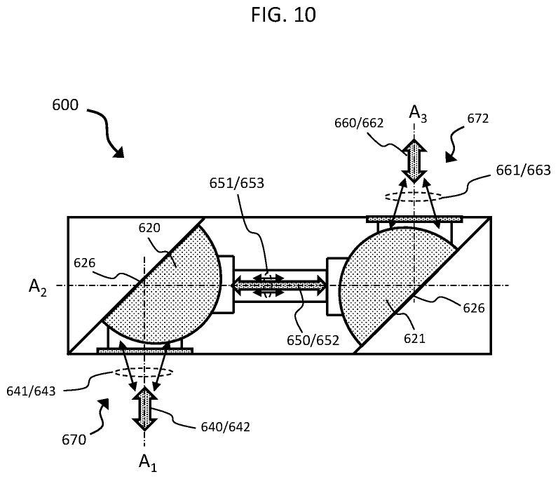

FIG. 10 shows a cross-section view of an example embodiment of the optical assembly 600 shown in FIG. 9, but without the waveguide 630. In this embodiment, optical radiation is propagating in free space between the optical elements 620 and 621, and is shown entering the first optical port 670 as diverging rays 641, that are reflected off the reflecting surface 626 and collimated by the first optical element 620 as collimated rays 651 propagating along a second optical axis A₂ to the second optical element 621, where they are reflected and focused by the second optical element 621 and propagate through the second optical port 672 along the third optical axis A₃ as converging rays 661. Counter-propagating radiation 662 enters the second optical port 672, propagating along the third optical axis A₃ as diverging rays 663 that are reflected and collimated by the second optical element 621 as collimated rays 653 of counter-propagating radiation 652 propagating along the second optical axis A₂ to the first optical element 620, where they are reflected and focused as converging rays 643 of counter-propagating radiation 642 exiting the first optical port 670, propagating along the first optical axis A₁.

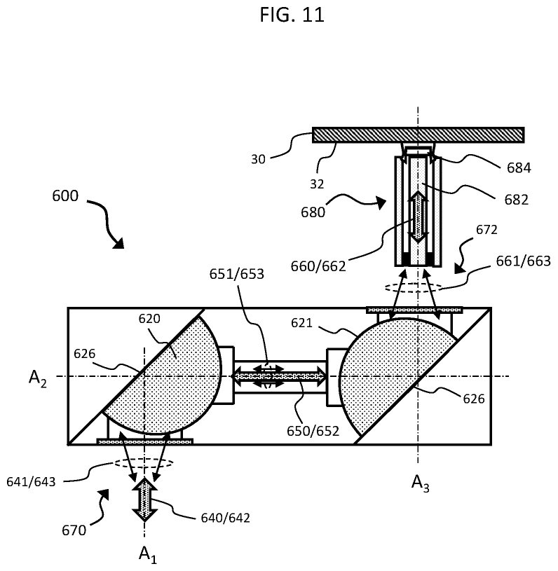

FIG. 11 shows a cross-section view of the optical assembly 600 shown in FIG. 10. In this embodiment, optical radiation entering the first optical port 670 is diverging rays 641, and is reflected off the reflecting surface 626 and collimated by the first optical element 620 as collimated rays 651 propagating along a second optical axis A₂ to the second optical element 621, where they are reflected and focused as rays 661 by the second optical element 621 and propagate through the second optical port 672 as optical radiation 660 propagating along the third optical axis A₃ into a light guide 682 of an optical assembly 680. In the illustrated embodiment, the optical assembly 680 is a fiber-optic temperature probe having a sensing element 684 in thermal communication with a target surface 32 of a target 30. Counter-propagating radiation 662 (e.g., luminescent radiation having different spectral content than the optical radiation 660) enters the second optical port 672, propagating along the third optical axis A₃ as diverging rays 663 that are reflected and collimated by the second optical element 620 as collimated rays 653 of counter-propagating radiation 652 propagating along the second optical axis A₂ to the first optical element 620, where they are reflected and focused as converging rays 643 of counter-propagating radiation 642 exiting the first optical port 670, propagating along the first optical axis A₁.

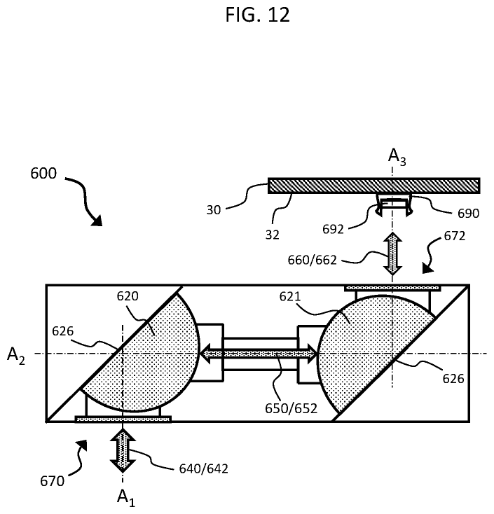

FIG. 12 shows a cross-section view of the optical assembly 600 shown in FIG. 11. In this embodiment, optical radiation 640 entering the first optical port 670 is reflected off the reflecting surface 626 of the optical element 620 as optical radiation 650, propagating along the second optical axis A₂ to the second optical element 621, where it is reflected by the second optical element 621 and propagates through the second optical port 672 as optical radiation 660 along the third optical axis A₃ into a to a sensing element 692 positioned in a sensing tip 690, both of which are in thermal communication with the target surface 32 of the target 30. In this illustrated embodiment, the components of the fiber-optic temperature probe 680 are not required. Counter-propagating radiation 662 (e.g., luminescent radiation having different spectral content than the optical radiation 660) enters the second optical port 672, that is reflected and collimated by the second optical element 620 as counter-propagating radiation 652 propagating along the second optical axis A₂ to the first optical element 620, where they are reflected as counter-propagating radiation 642 exiting the first optical port 670, propagating along the first optical axis A₁.

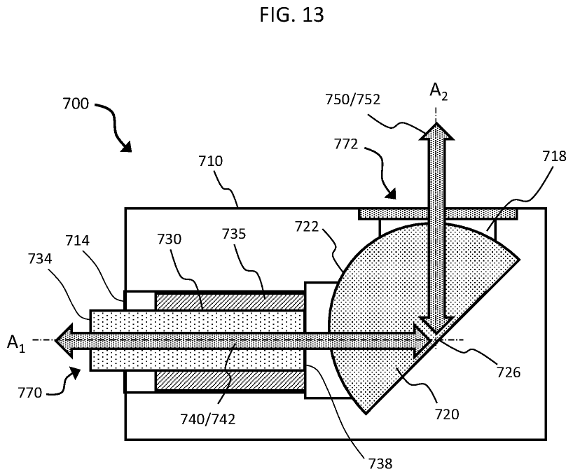

FIG. 13 shows a cross-section view of an example embodiment of an optical assembly 700. The optical assembly 700 may be used as a component of a distance sensor, a presence sensor, an edge finder, a temperature sensor, an optical spectrum sensor, or any of a wide variety of sensors or sensor systems. The optical assembly 700 includes a housing 710 having a first passage 714 and a second passage 718 formed therein. An optical element 720 is provided in similar fashion to the optical element 120 described above with respect to optical assembly 100, having a first surface 722 and a reflecting surface 726. An optical waveguide 730 having a first end 734 and a second end 738 is mounted in a ferrule or other structural member 735 that is positioned in the first passage 714. The waveguide 730 defines a first optical port 770 and a first optical axis A₁. In various embodiments, the optical element 720 and waveguide 730 may be provided as described above with respect to the optical element 120 and the optical waveguide 130 (along with any and all of the alternatives, configurations, variations, and combinations thereof), respectively. Also, other structures or features of the optical assembly 700 may be provided in similar fashion as those described herein with respect to the optical assembly 100, 200, 300, 400, and 600 (along with any and all of the alternatives, configurations, variations, and combinations thereof).

The optical assembly 700 is configured to change the direction of propagation of optical radiation 740 propagating along a first optical axis A₁ to propagating as optical radiation 750 along a second optical axis A₂ (and the same in reverse for counter-propagating optical radiation 752 to counter-propagating optical radiation 742) as described below. The waveguide 730 is configured to guide the optical radiation 740 from the first optical port 770 to the optical element 720. The optical element 720 receives, reflects and focuses the optical radiation 740 as optical radiation 750 propagating along the second optical axis A₂ until it exits a second optical port 772. Counter-propagating radiation 752 may enter the second optical port 772 where it propagates along the second optical axis A₂ to the optical element 720, where it may be reflected and focused into the optical waveguide 730 as counter-propagating optical radiation 742 that propagates along the first optical axis A₁ until it exits the first optical port 770. While FIG. 13 shows the angle between the first optical axis A₁ and the optical axis A₂ as 90 degrees, the optical assembly 700 may be configured to change the direction of propagation of optical radiation at any angle and optionally may be configured such that the angle is adjustable.

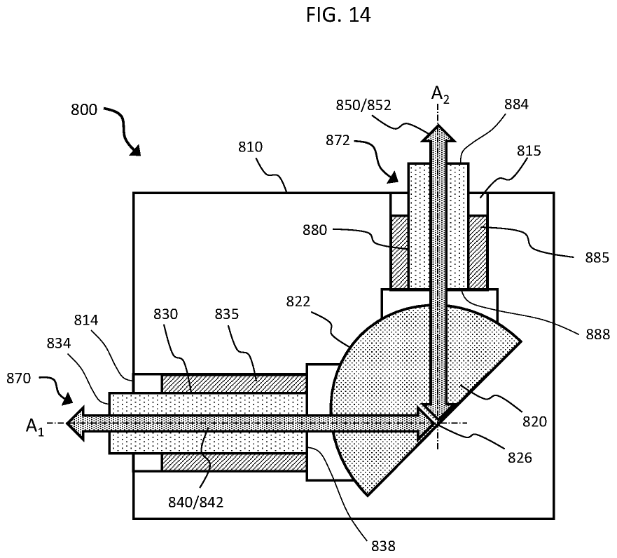

FIG. 14 shows a cross-section view of an example embodiment of an optical assembly 800. The optical assembly 800 may be used as a component of a distance sensor, a presence sensor, an edge finder, a temperature sensor, an optical spectrum sensor, or any of a wide variety of sensors or sensor systems. In the illustrated embodiment, the optical assembly 800 includes a housing 810 having a first passage 814 and a second passage 815 formed therein. An optical element 820 may be provided in similar fashion to the optical element 120 described above with respect to the optical assembly 100, having a first surface 822 and a reflecting surface 826. A first optical waveguide 830 mounted in a ferrule or other structural member 835 is positioned in the first passage 814. A second optical waveguide 880 mounted in a structural member or ferrule 885 is positioned in the second passage 815. In some embodiments, one or both of the ferrules 835, 885 may be mounted in at least one rotating joint (not shown) operative to allow the waveguides 830, 880 to rotate in a plane orthogonal to the directions of propagation of the radiation 840/842, 850/852 or the optical axes A₁ and A₂. In various embodiments, the optical element 820 and waveguides 830 and 880 may be provided as described above with respect to the optical element 120 and the optical waveguide 130 (along with any and all of the alternatives, configurations, variations, and combinations thereof), respectively. Also, other structures or features of the optical assembly 800 may be provided in similar fashion as those described herein with respect to the optical assembly 100, 200, 300, 400, and 600 (along with any and all of the alternatives, configurations, variations, and combinations thereof).

The optical assembly 800 is configured to change the direction of propagation of optical radiation 840 propagating along a first optical axis A₁ to propagating as optical radiation 850 along a second optical axis A₂ (and the same in reverse for counter-propagating optical radiation 852 to counter-propagating optical radiation 842) as described below. The first waveguide 830 has a first end 834 and a second end 838 defining the first optical axis A₁. The second waveguide 880 includes a first end 884 and a second end 888 defining the second optical axis A₂. The second end 884 of the second waveguide 880 defines a first optical port 870. The first waveguide 830 is configured to guide the optical radiation 840 from the first optical port 870 to the optical element 820. The optical element 820 receives, reflects and focuses the optical radiation 840 as optical radiation 850 coupled into the second waveguide 880 where it propagates through the second waveguide 880 along the second optical axis A₂ until it exits the second optical port 872. Counter-propagating radiation 852 enters second optical port 872 where it propagates through the waveguide 880 along the optical axis A₂ to the optical element 820, where it is reflected and focused into the first optical waveguide 830 as counter-propagating optical radiation 842 where it propagates along the first optical axis A₁ until it exits the first optical port 870. While FIG. 14 shows the angle between the first optical axis A₁ and the optical axis A₂ as 90 degrees, the optical assembly 800 may be configured to change the direction of propagation of optical radiation at any angle and optionally may be configured such that the angle is adjustable.

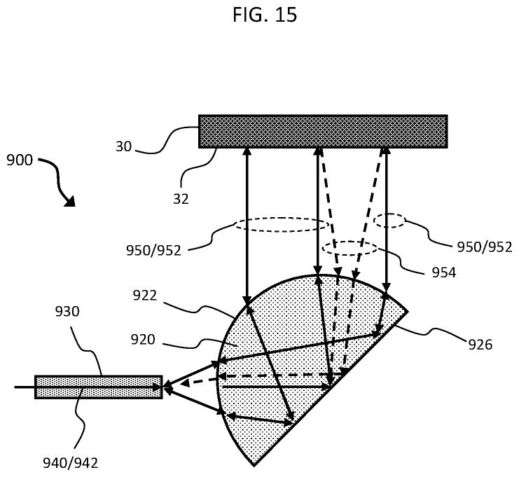

FIGS. 15-20 show various example embodiments of optical arrangements of waveguides and optical elements that may be suitable for use with the optical assemblies 100, 200, 300, 400, and 600. These FIGS. are meant to show just a few of many possible arrangements of optical waveguides and optical elements that may be substituted for the arrangement of these elements in the embodiments described above. Those skilled in the art will appreciate that the components shown in FIGS. 15-20 may be substituted for each other in multiple combinations.

FIG. 15 shows a cross-section view of an example embodiment of an optical arrangement 900 (e.g., portions of a reflective sensor). The optical arrangement 900 may be used as a component of a distance sensor, a presence sensor, an edge finder, a temperature sensor, an optical spectrum sensor, or any of a wide variety of sensors or sensor systems. The optical arrangement 900 includes at least one waveguide 930 and at least one optical element 920 having a first surface 922 and a reflecting surface 926. Optical radiation 940 propagates through the waveguide 930 (e.g., from a light source) where it is reflected by the reflecting surface 926 as optical radiation 950 propagating toward a sensed surface (e.g., the target surface 32 of a sensed material (e.g., the target 30). Some rays of the radiation 950 are reflected from the target surface 32 as reflected radiation or rays 952 at the same angle relative to normal of the target surface 32 as the incident rays. Other rays of the radiation 950 are scattered by the target surface 32 as scattered radiation or rays 954. As such, the target surface 32 is a reflective surface that may produce some specular reflection and/or some diffuse reflection (e.g., due to scattering) depending on properties of the material of the target 30 and the quality or roughness of the target surface 32. The scattered rays 954 may come off the target surface 32 over a range of angles because of the roughness of the target surface 32. A sensor using this optical configuration might sense a change from specular to diffuse reflection or vice versa of a target surface that has a rough portion and a smooth or “mirror-like” portion as the sensor moves horizontally with respect to (i.e., parallel to) the target surface 32. The reflected rays 952 and the scattered rays 954 are reflected by the reflecting surface 926 as counter-propagating radiation 940 through the waveguide 930.

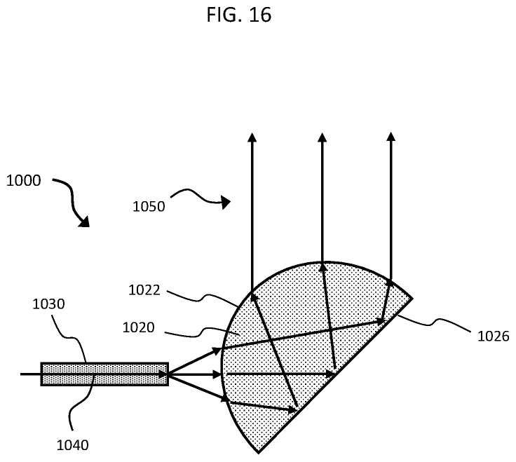

FIG. 16 shows a cross-section view of an example embodiment of an optical arrangement 1000. The optical arrangement 1000 may be used as a component of a distance sensor, a presence sensor, an edge finder, a temperature sensor, an optical spectrum sensor, or any of a wide variety of sensors or sensor systems. Optical radiation 1040 propagates through an optical waveguide 1030 (e.g., from a light source) and is incident on a first surface 1022 of an optical element 1020. In the illustrated embodiment, the optical element 1020 is provided as a half ball lens. In other embodiments, the optical element 1020 may be provided as a ball lens, a cylindrical lens, an aspheric lens, a hyper-hemispherical lens, a hypo-hemispherical lens, a hemi-ellipsoidal lens or a hemispherical lens hemispherical and the like or any combination thereof. The optical radiation 1040 diverges as it leaves the waveguide 1030, then propagates into the lens 1020, reflects off a second surface 1026, and continues to propagate through the lens 1020 before exiting the first surface 1022 where it is collimated and propagates through free space as collimated optical radiation 1050. The condition for collimation is that the distance between the optical waveguide 1030 and ball lens is BFL (back focal length)=nD/(4(n−1))−D/2, wherein D is the ball lens diameter and n is the ball lens refractive index.

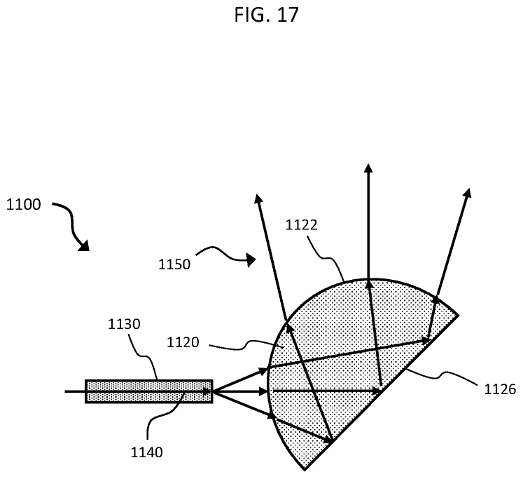

FIG. 17 shows a cross-section view of an example embodiment of an optical arrangement 1100. The optical arrangement 1100 may be used as a component of a distance sensor, a presence sensor, an edge finder, a temperature sensor, an optical spectrum sensor, or any of a wide variety of sensors or sensor systems. The optical arrangement 1100 produces diverging optical radiation from an optical waveguide 1130. This is done by changing the spacing between the optical waveguide and a ball (or hemispherical or cylindrical) lens surface. Optical radiation 1140 propagates through the optical waveguide 1130 (e.g., from a light source) and is incident on a surface 1122 of an optical element 1120 (shown here as a hemispherical lens). The optical radiation 1140 diverges as it leaves the waveguide 1130, then propagates through the surface 1122 into the lens 1120, reflects off the surface 1126, and continues to propagate through the lens 1120 before propagating through the surface 1122 and into free space as diverging optical radiation 1150.

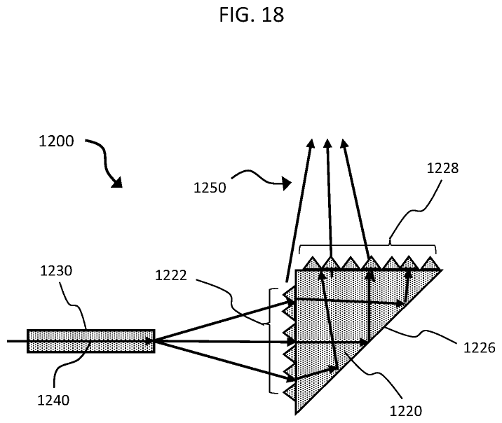

FIG. 18 shows a cross-section view of an embodiment of an optical arrangement 1200 that focuses optical radiation using Fresnel lens surfaces. The optical arrangement 1200 may be used as a component of a distance sensor, a presence sensor, an edge finder, a temperature sensor, an optical spectrum sensor, or any of a wide variety of sensors or sensor systems. Optical radiation 1240 propagates through an optical waveguide 1230 (e.g., from a light source) and is incident on a first surface 1222 of an optical element 1220. In this embodiment, the first surface 1222 is provided as a Fresnel lens surface that serves to focus the optical radiation 1240 as it propagates therethrough. The optical radiation 1240 diverges as it leaves the waveguide 1230, then propagates through the first surface 1222 into the optical element 1220, reflects off a reflecting surface 1226, and continues to propagate through the optical element 1220 and through a second surface 1228 that is also provided as a Fresnel lens surface, so the optical radiation is focused by the second surface 1228 and propagates into free space as converging optical radiation 1250.

Those skilled in the art will appreciate that the optical elements 920, 1120, and 1220 (or a combination thereof) may be used in any of the optical assemblies 100, 200, 300, 400, 600, 700, or 800.

The foregoing is illustrative of embodiments and examples of the invention, and is not to be construed as limiting thereof. Although a few specific embodiments and examples have been described with reference to the drawings, those skilled in the art will readily appreciate that many modifications to the disclosed embodiments and examples, as well as other embodiments, are possible without materially departing from the novel teachings and advantages of the invention. Accordingly, all such modifications to the subject matter described herein are intended to be included within the scope of the invention as defined in the claims. For example, skilled persons will appreciate that the subject matter of any sentence, paragraph, example or embodiment can be combined with subject matter of some or all of the other sentences, paragraphs, examples or embodiments, except where such combinations are mutually exclusive. The scope of the present invention should, therefore, be determined by the following claims, with equivalents of the claims to be included therein.

What is claimed is:

1. An optical assembly comprising:
at least one housing; and
at least one optical element disposed at least partially within the at least one housing and having at least one curved surface and at least one reflective surface,
wherein the at least one optical element is configured to direct a first optical radiation incident on a first portion of the at least one curved surface to exit a second portion of the at least one curved surface after at least partially reflecting from at least a portion of the at least one reflective surface,
wherein the optical radiation incident on the first portion of the at least one curved surface has a first direction of propagation along a first optical axis and the optical radiation exiting the second portion of the at least one curved surface has a second direction of propagation along a second optical axis, wherein the second direction of propagation is different from the first direction of propagation.

2. The optical assembly of claim 1, wherein the angle between the first optical axis and the second optical axis is between 10° and 170°.

3. The optical assembly of claim 1, wherein the at least one optical element comprises a single optical element.

4. The optical assembly of claim 1, wherein the at least one optical element is selected from the group consisting of a half ball lens, a hyper-hemispherical lens, a hypo-hemispherical lens, a hemi-ellipsoidal lens or a hemispherical lens.

5. The optical assembly of claim 1, wherein the at least one optical element is selected from a group consisting of silica, fused silica, soda lime glass, borosilicate glass, sapphire, aluminum nitride, silicone (RTV), color glass, IR/UV optical materials (Silicon, Zinc sulfide, Germanium, Arsenic trisulfide, Barium fluoride, Calcium fluoride, Magnesium fluoride, Zinc Selenide, silicon carbide, or plastic.

6. The optical assembly of claim 1, wherein the at least one optical element is further configured to direct optical radiation incident on the second portion of the at least one curved surface to exit the first portion of the at least one curved surface after at least partially reflecting or refracting from at least a portion of the reflective surface,
wherein the optical radiation incident on or exiting the first portion of the at least one curved surface has a first direction of propagation and the optical radiation incident on or exiting the second portion of the at least one curved surface has a second direction of propagation, wherein the second direction of propagation is different from the first direction of propagation.

7. The optical assembly of claim 1, wherein the at least one reflective surface comprises at least one reflecting layer disposed over at least a portion of the at least one reflective surface.

8. The optical assembly of claim 7, wherein the at least one reflecting layer comprises at least one of a dichroic mirror, a total internal reflection mirror, at least one metal film, and at least one dielectric film or coating.

9. The optical assembly of claim 1, further comprising an interferometric structure disposed over at least a portion of the reflective surface.

10. The optical assembly of claim 1, wherein the at least one optical element is configured to collimate the beam of optical radiation exiting the second portion of the at least one curved surface.

11. The optical assembly of claim 1, wherein the at least one optical element is configured to focus the beam of optical radiation at a distance from the second portion of the at least one curved surface, wherein the focal length of the at least one optical element is between 1 mm and 350 mm.

12. The optical assembly of claim 1, wherein a dimension of the at least one housing perpendicular to the first direction of propagation is 6 mm or less.

13. The optical assembly of claim 3, further comprising:
(i) an optical radiation source configured to emit a first optical radiation or an outgoing signal having a first spectral power distribution; and
(ii) a detector configured to measure a second optical radiation or a returning signal having a second spectral power distribution, wherein the first optical radiation or outgoing signal is incident on the first portion of the at least one curved surface and the second optical radiation or returning signal exits the first portion of the at least one curved surface.

14. The optical assembly of claim 13, wherein the first spectral power distribution is different from the second spectral power distribution.

15. The optical assembly of claim 13, further comprising a reflective surface, wherein the reflective surface is configured to reflect at least a portion of optical radiation exiting from the second portion of the at least one curved surface and direct it back into the second portion of the at least one curved surface.

16. The optical assembly of claim 13, wherein the optical assembly is at least a component of at least one of a temperature sensor, a presence sensor, or a distance sensor.

17. The optical assembly of claim 13, further comprising a sensing element configured to emit the second optical radiation or returning signal, wherein the sensing element comprises a phosphor and the optical assembly is as at least a component of a temperature sensor.

18. The optical assembly of claim 1, further comprising a first optical waveguide having a first end and a second end, wherein the second end is at least partially disposed within the at least one housing, and wherein the first optical waveguide configured to:
(i) allow a first optical radiation to propagate from the first end to the second end; and
(ii) allow a second optical radiation to propagate from the second end to the first end, wherein the second end of the first optical waveguide is in optical communication with the first portion of the at least one curved surface.

19. The optical assembly of claim 18, wherein the first optical waveguide comprises at least one fiber bundle and at least one of an optical rod, a hollow optical rod, a double-clad fiber, a light pipe, a glass rod, or a sapphire rod.

20. The optical assembly of claim 19, wherein the at least one of the optical rod, the hollow optical rod, the double-clad fiber, the light pipe, the glass rod, or the sapphire rod is disposed between the at least one fiber bundle and the at least one optical element.

21. The optical assembly of claim 18 further comprising a rotating joint configured to allow the first optical waveguide to rotate in a plane orthogonal to the first direction of propagation.

22. An optical assembly, comprising:
a housing;
a first optical waveguide defining a first optical axis, wherein the first optical waveguide includes a first end and a second end, the second end at least partially disposed within the housing, wherein the first optical waveguide is configured to allow a first optical radiation to propagate from the first end to the second end and to allow a second optical radiation to propagate from the second end to the first end;
a first optical port through which the first optical radiation may propagate;
a second optical port through which the second optical radiation may propagate;
at least one optical element comprising at least one curved surface and at least one reflective surface, wherein:
(i) the second end of the first optical waveguide is in optical communication with a first portion of the at least one curved surface of the at least one optical element;
(ii) the first optical port is in optical communication with a first portion of the at least one curved surface of the at least one optical element;
(iii) the second optical port is in optical communication with a second portion of the at least one curved surface of the at least one optical element;
(iv) at least a portion of the first portion of the at least one curved surface is different from at least a portion of the second portion of the at least one curved surface; and
(v) the at least one optical element is configured to (a) direct the first optical radiation from the first optical waveguide to the second optical port and (b) direct the second optical radiation from the second optical port to the first optical waveguide.

23. The optical assembly of claim 22 further comprising a rotating joint configured to allow the first optical waveguide to rotate in a plane orthogonal to the first direction of propagation.

24. An optical assembly comprising:
at least one housing;
at least one first optical element coupled to the at least one housing and having at least one first curved surface and at least one first reflective surface;
at least one second optical element coupled to the at least one housing in optical communication with the at least one first optical element, and having at least one second curved surface and at least one second reflective surface;
at least one optical waveguide in optical communication with the at least one first optical element and the at least one second optical element, wherein the at least one optical waveguide has a first end, a second end, and a second optical axis;
wherein the at least one first optical element is configured to receive a first optical radiation propagating along a first optical axis and to direct the first optical radiation as second optical radiation to the optical waveguide propagating along the second optical axis,
wherein the at least one second optical element is configured to receive the second optical radiation from the at least one optical waveguide and direct the second optical radiation as third optical radiation propagating along a third optical axis.

25. The optical assembly of claim 24, wherein the at least one second optical element is configured to receive a fourth optical radiation propagating along the third optical axis and to direct the fourth optical radiation as fifth optical radiation to the optical waveguide propagating along the second optical axis,
wherein the at least one first optical element is configured to receive the fifth optical radiation from the at least one optical waveguide and direct the fifth optical radiation as sixth optical radiation propagating along the first optical axis.

26. The optical assembly of claim 25, wherein the third optical radiation includes excitation radiation propagating along the third optical axis to at least one sensing element, and the fourth optical radiation includes fluorescent radiation counter-propagating along the third optical axis.

27. The optical assembly of claim 25, wherein the first optical radiation, the second optical radiation, and the third optical radiation include excitation radiation propagating to at least one sensing element, and the fourth optical radiation, the fifth optical radiation, and the sixth optical radiation include fluorescent radiation counter-propagating to at least one detector.

28. The optical assembly of claim 27, further comprising an optical radiation source configured to emit the excitation radiation propagating along the first optical axis.
